(19) United States
(12) Patent Application Publication
(10) Pub. No.: US 2025/0379798 A1
(43) Pub. Date: Dec. 11, 2025

(54) DEVICE CAPABILITY DISCOVERY METHOD AND WIRELESS COMMUNICATION DEVICE

(71) Applicant: SHENZHEN TCL NEW TECHNOLOGY CO., LTD., Shenzhen, Guangdong (CN)

(72) Inventor: Jia SHENG, Shenzhen, Guangdong (CN)

(73) Assignee: SHENZHEN TCL NEW TECHNOLOGY CO., LTD., Shenzhen, Guangdong (CN)

(21) Appl. No.: 18/877,968

(22) PCT Filed: Jun. 22, 2022
(86) PCT No.: PCT/CN2022/100544

§ 371 Date: Dec. 20, 2024

(51) Int. Cl. H04L 41/16; H04B 7/06

(52) U.S. Cl. CPC H04L 41/16; H04B 7/0626

(57) ABSTRACT

The disclosure provides a device capability discovery method and a wireless communication device. The wireless communication device transmits a capability message of the wireless communication device to a source device having a pool of machine learning (ML) models. The capability message shows whether the wireless communication device is capable of executing multiple ML models. The wireless communication device downloads if needed, and activates one or more ML models from a subset in the pool of ML models. The subset in the pool of ML models matches the capability message of the wireless communication device.

### TECHNICAL FIELD

The present disclosure relates to the field of communication systems, and more particularly, to a device capability discovery method and a wireless communication device.

### BACKGROUND ART

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN comprises a set of base stations (BSs) that provide wireless links to the UEs located in cells covered by the base station, and an interface to a core network (CN) which provides overall network control. As will be appreciated the RAN and CN each conduct respective functions in relation to the overall network. The 3rd Generation Partnership Project has developed the so-called Long Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a gNB.

### Technical Problem

In 3GPP Rel-18, a study item (SI) “Artificial Intelligence (AI)/Machine Learning (ML) for NR Air Interface” will start to develop. The AI/ML is applied to the 3GPP telecommunication system, and several use cases are investigated and studied, including enhanced channel state information (CSI) feedback, the beam management and the positioning.

Typically, the beam selection is based on the measurement of channel state information (CSI)-reference signal (CSI-RS)/synchronization signal block (SSB). This process costs a large amount of reference signals and delay. Thus, predictive beam switching is proposed to reduce the delay. Applying ML to beam management is to be studied.

A telecommunication device, such as a UE, can run multiple AI/ML models for different use cases. Multiple AI/ML models may be deployed for a single use case. How to manage multiple AI/ML models in a telecommunication device is still unclear.

On the other hand, generalization of AI/ML model for a UE is under development. A generalized AI/ML model is known as an AI/ML model that works for all subset of unseen data. There is no single generalized AI/ML model universally qualified to fit all the scenarios or use cases of a UE. Hence, a device capability discovery method is desirable.

### Technical Solution

An object of the present disclosure is to propose a wireless communication device, such as a user equipment (UE) or a base station, and a device capability discovery method based on machine learning.

In a first aspect, an embodiment of the invention provides device capability discovery method for machine learning (ML), executable in a wireless communication device, comprising:
transmitting a capability message of the wireless communication device to a source device having a pool of machine learning (ML) models, wherein the capability message shows whether the wireless communication device is capable of executing multiple ML models; and downloading one or more ML models from a subset in the pool of ML models, wherein the subset in the pool of ML models matches the capability message of the wireless communication device.

In a second aspect, an embodiment of the invention provides a wireless communication device comprising a processor configured to call and run a computer program stored in a memory, to cause a device in which the processor is installed to execute the disclosed method.

In a third aspect, an embodiment of the invention provides device capability discovery method for machine learning (ML), executable in a wireless communication device, comprising:
transmitting a capability message of the wireless communication device to a base station, and the wireless communication device having a pool of machine learning (ML) models, wherein the capability message shows whether the wireless communication device is capable of executing multiple ML models;
receiving an indication showing a subset of ML models, wherein the subset of ML models matches the capability message of the wireless communication device; and
activating one or more ML models deployed in the wireless communication device in response to the subset of ML models.

In a fourth aspect, an embodiment of the invention provides a wireless communication device comprising a processor configured to call and run a computer program stored in a memory, to cause a device in which the processor is installed to execute the disclosed method.

The disclosed method may be implemented in a chip. The chip may include a processor, configured to call and run a computer program stored in a memory, to cause a device in which the chip is installed to execute the disclosed method.

The disclosed method may be programmed as computer-executable instructions stored in non-transitory computer-readable medium. The non-transitory computer-readable medium, when loaded to a computer, directs a processor of the computer to execute the disclosed method.

The non-transitory computer-readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

The disclosed method may be programmed as a computer program product, which causes a computer to execute the disclosed method.

The disclosed method may be programmed as a computer program, which causes a computer to execute the disclosed method.

### Advantageous Effects

Multiple AI/ML models can run in a set of telecommunication devices, such as a UE and/or a gNB. Some embodiments of the disclosure provide a mechanism that enables a UE to support multiple AI/ML models. It is more general and reasonable for a UE to run multiple ML models.

Some embodiments of the disclosure provide relationships between model complexity and UE capability. With the relationships between model complexity and UE capability, the UE and gNB can support diverse AI/ML models easily with various complexity levels. Rather than handling the hardware details of a UE or individual model details of parameter number, model size and etc., a simplified rule or protocol is provided to associate model complexity and UE capability.

The UE capability becomes configurable for the deployment of at least one AI/ML model. The relation/correlation between detailed UE capabilities is investigated.

### DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure. A person having ordinary skill in this field can obtain other figures according to these figures without paying the premise.

FIG. 1 illustrates a schematic view showing an example wireless communication system comprising a user equipment (UE), a base station, and a network entity.

FIG. 2 illustrates a schematic view showing a system for executing a device capability discovery method.

FIG. 3 illustrates a schematic view showing an embodiment of the disclosed method.

FIG. 4 illustrates a schematic view showing another embodiment of the disclosed method.

FIG. 5 illustrates a schematic view showing still another embodiment of the disclosed method.

FIG. 6 illustrates a schematic view showing a mapping between generalized AI/ML model a scenario-specific AI/ML model.

FIG. 7 illustrates a schematic view showing a system for wireless communication according to an embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Embodiments of the disclosure are related to artificial intelligence (AI) and machine learning (ML) for new radio (NR) air interface and address problems of device capability discovery and model generalization.

This disclosure is about the UE capability in the view of complexity. The multiple AI/ML model aspect is investigated. The model generalization and complexity are discussed. A complexity level rule is proposed. Such that, the UE capability related AI/ML model complexity are clarified.

These AI/ML models can belong to the same use case or different use cases. Thus, a related problem is how to define the UE capability to support the multiple AI/ML models.

How to support the generalized AI/ML model need to be studied. How to support the generalized capability of a generalized AI/ML model needs to be answered.

Another question is related to model complexity. How to describe the relationship between the model complexity and UE capability has not been defined.

In another case, when the computing power, memory and storage are occupied by deployed AI/ML models, some UE capability should not be fixed. They can be flexibly configured, even enabled/disabled.

When there are limited resources, the deployed AI/ML models are configured, and enable/disabled according to a priority order.

A generalized AI/ML model is an AI/ML model trained to work for all sets of unseen data. In machine learning, generalization is a definition to demonstrate how well is a trained model classifies or forecast unseen data. The trained capability of a generalized AI/ML model may be referred to as generalization capability. A proper way to evaluate trained capability of a generalized AI/ML model is to compare performance of the generalized AI/ML model with performance of a scenario-specific AI/ML model. A scenario-specific is an ML model trained and tested with the data set of the same settings without model generalization.

For simplicity, an AI/ML model, AI/ML model, and model are interchangeably used in the description. In the description of embodiments of the disclosure, model switching comprises switching off or deactivating a model and switching on or activating another model. A third node may comprise an application server, a gNB, or a UE.

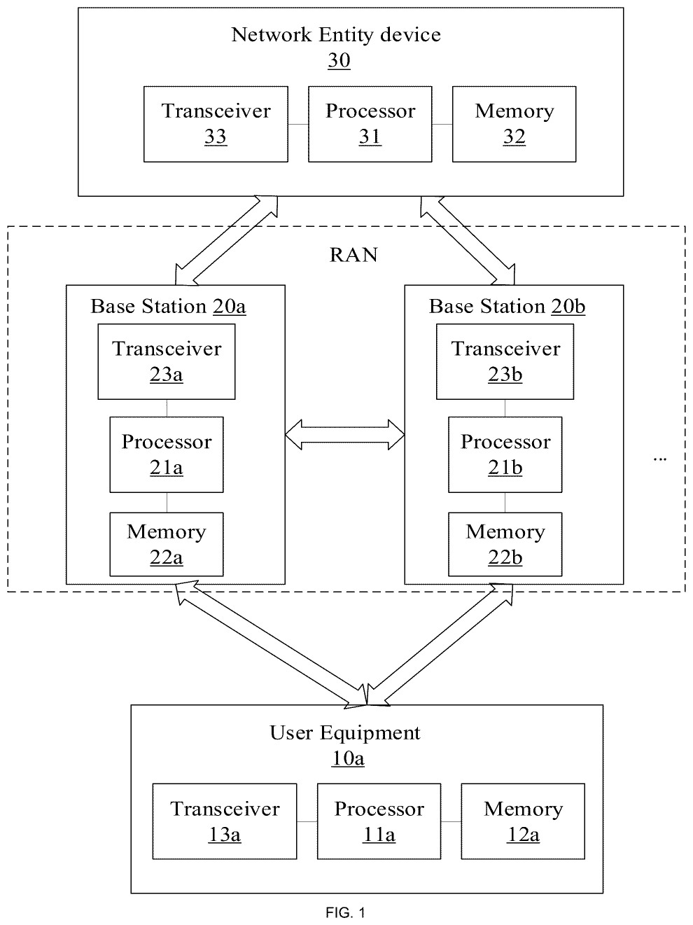

With reference to FIG. 1, a telecommunication system including a UE 10a, a base station 20a, a base station 20b, and a network entity device 30 executes the disclosed method according to an embodiment of the present disclosure. FIG. 1 is shown for illustrative, not limiting, and the system may comprise more UEs, BSs, and CN entities. Connections between devices and device components are shown as lines and arrows in the FIGs. The UE 10a may include a processor 11a, a memory 12a, and a transceiver 13a. The base station 20a may include a processor 21a, a memory 22a, and a transceiver 23a. The base station 20b may include a processor 21b, a memory 22b, and a transceiver 23b. The network entity device 30 may include a processor 31, a memory 32, and a transceiver 33. Each of the processors 11a, 21a, 21b, and 31 may be configured to implement the proposed functions, procedures, and/or methods described in this description. Layers of radio interface protocol may be implemented in the processors 11a, 21a, 21b, and 31. Each of the memory 12a, 22a, 22b, and 32 operatively stores a variety of programs and information to operate a connected processor. Each of the transceivers 13a, 23a, 23b, and 33 is operatively coupled with a connected processor, and transmits and/or receives a radio signal. Each of the base stations 20a and 20b may be an eNB, a gNB, or one of other radio nodes.

Each of the processors 11a, 21a, 21b, and 31 may include a general-purpose central processing unit (CPU), application-specific integrated circuits (ASICs), other chipsets, logic circuits and/or data processing devices. Each of the memory 12a, 22a, 22b, and 32 may include read-only memory (ROM), a random-access memory (RAM), a flash memory, a memory card, a storage medium and/or other storage devices. Each of the transceivers 13a, 23a, 23b, and 33 may include baseband circuitry and radio frequency (RF) circuitry to process radio frequency signals. When the embodiments are implemented in software, the techniques described herein can be implemented with modules, procedures, functions, entities and so on, that perform the functions described herein. The modules can be stored in a memory and executed by the processors. The memory can be implemented within a processor or external to the processor, in which those can be communicatively coupled to the processor via various means are known in the art.

The network entity device 30 may be a node in a CN. CN may include LTE CN or 5GC which may include user plane function (UPF), session management function (SMF), mobility management function (AMF), unified data management (UDM), policy control function (PCF), control plane (CP)/user plane (UP) separation (CUPS), authentication server (AUSF), network slice selection function (NSSF), and the network exposure function (NEF).

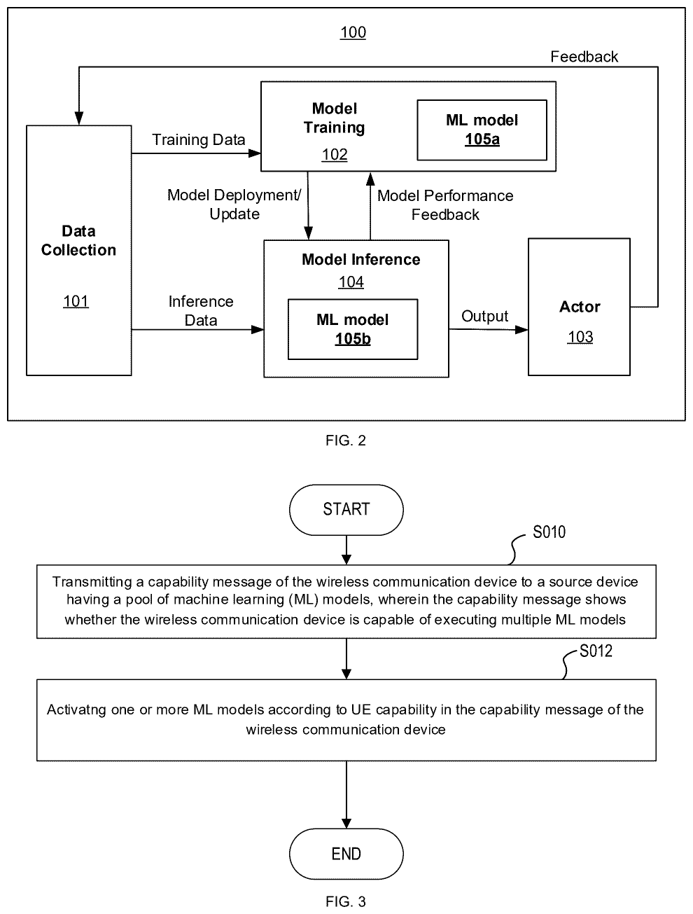

With reference to FIG. 2, a system 100 for the device capability discovery method based on machine learning comprises units of data collection 101, model training unit 102, actor 103, and model inference 104. Please note that FIG. 2 does not necessarily limit the device capability discovery method to the instant example. The device capability discovery method is applicable to any design based on machine learning. The general steps comprise data collection and/or model training and/or model inference and/or (an) actor(s).

The data collection unit 101 is a function that provides input data to the model training unit 102 and the model inference unit 104. AI/ML algorithm-specific data preparation (e.g., data pre-processing and cleaning, formatting, and transformation) is not carried out in the data collection unit 101.

Examples of input data may include measurements from UEs or different network entities, feedback from Actor 103, and output from an AI/ML model.

Training data is data needed as input for the AI/ML Model training unit 102.

Inference data is data needed as input for the AI/ML Model inference unit 104.

The model training unit 102 is a function that performs the ML model training, validation, and testing. The Model training unit 102 is also responsible for data preparation (e.g., data pre-processing and cleaning, formatting, and transformation) based on training data delivered by the data collection unit 101, if required.

Model Deployment/Update between units 102 and 104 involves deployment or update of an AI/ML model (e.g., a trained machine learning model 105a or 105b) to the model inference unit 104. The model training unit 102 uses data units as training data to train a machine learning model 105a and generates a trained machine learning model 105b from the machine learning model 105a.

The model inference unit 104 is a function that provides AI/ML model inference output (e.g., predictions or decisions). The AI/ML model inference output is the output of the machine learning model 105b. The Model inference unit 104 is also responsible for data preparation (e.g., data pre-processing and cleaning, formatting, and transformation) based on inference data delivered by the data collection unit 101, if required.

The output shown between unit 103 and unit 104 is the inference output of the AI/ML model produced by the model inference unit 104.

Actor 103 is a function that receives the output from the model inference unit 104 and triggers or performs corresponding actions. The actor 103 may trigger actions directed to other entities or to itself.

Feedback between unit 103 and unit 101 is information that may be needed to derive training or inference data or performance feedback.

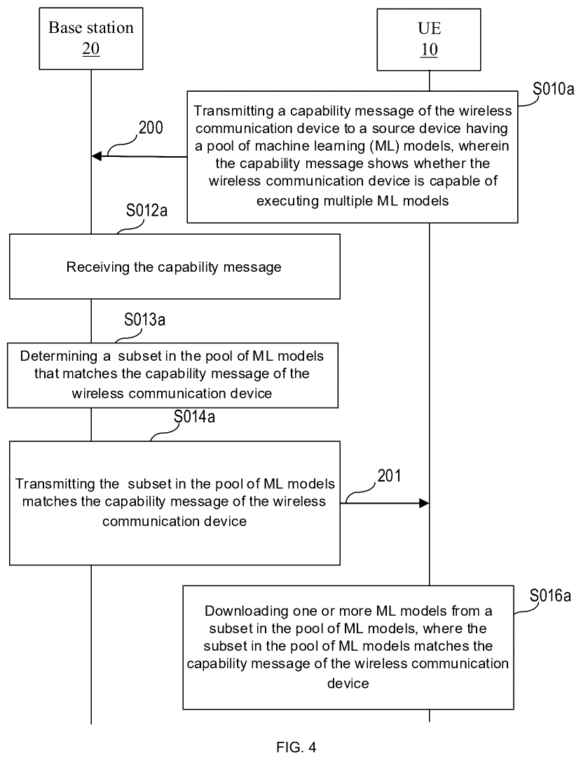

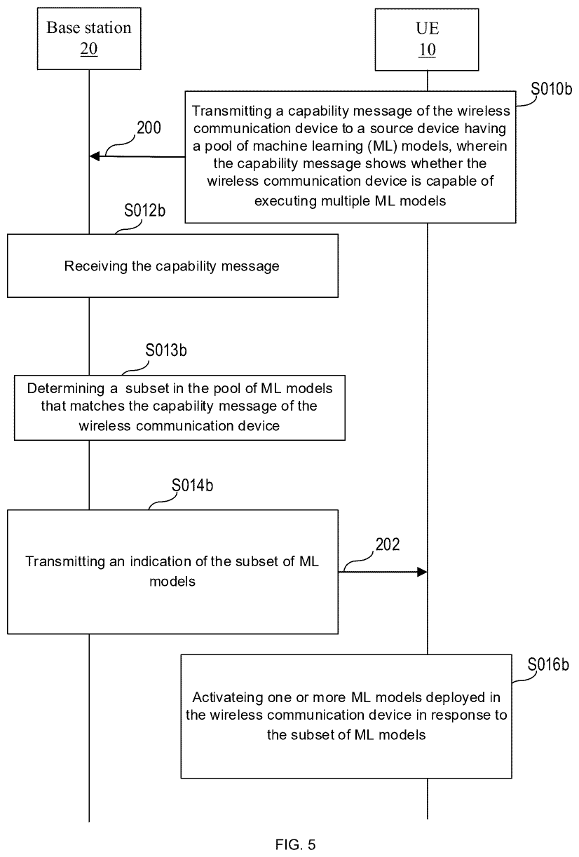

With reference to FIG. 3, FIG. 4, and FIG. 5, an example of a UE 10 in the description may include one of the UE 10a. Examples of a gNB 20 in the description may include the base station 20a or 20b. Note that even though the gNB is described as an example of base station in the following, the disclosed method of may be implemented in any other types of base stations, such as an eNB or a base station for beyond 5G. Uplink (UL) transmission of a control signal or data may be a transmission operation from a UE to a base station. Downlink (DL) transmission of a control signal or data may be a transmission operation from a base station to a UE. The disclosed method is detailed in the following. The UE 10 and a base station, such as a gNB 20, execute the device capability discovery method based on machine learning.

FIG. 3 shows an embodiment of the disclosed method. At least one wireless communication device executes a device capability discovery method based on machine learning. In an embodiment, the at least one wireless communication device may comprise a user equipment (UE). In another embodiment, the at least one wireless communication device may comprise a base station. In still another embodiment, the at least one wireless communication device may comprise a combination of UEs and base stations.

With reference to FIG. 3, an example of a UE 10 in the description may include one of the UE 10a. Examples of a gNB 20 in the description may include the base station 20a or 20b. Note that even though the gNB is described as an example of base station in the following, the disclosed method of may be implemented in any other types of base stations, such as an eNB or a base station for beyond 5G. Uplink (UL) transmission of a control signal or data may be a transmission operation from a UE to a base station. Downlink (DL) transmission of a control signal or data may be a transmission operation from a base station to a UE. The disclosed method is detailed in the following. The UE 10 and a base station, such as a gNB 20, execute the device capability discovery method based on machine learning.

FIG. 3 shows an embodiment of the disclosed method. At least one wireless communication device executes a device capability discovery method. In an embodiment, the at least one wireless communication device may comprise a user equipment (UE). In another embodiment, the at least one wireless communication device may comprise a base station. In still another embodiment, the at least one wireless communication device may comprise a combination of UEs and base stations.

With reference to FIG. 3, the UE 10 transmits a capability message of the wireless communication device to a source device having a pool of machine learning (ML) models, wherein the capability message shows whether the wireless communication device is capable of executing multiple ML models (S010). The wireless communication device comprises a user equipment (UE), such as UE 10. The source device comprises a base station, such as gNB 20. The capability message may comprise a model type. In an embodiment, the model type may comprise one or more of:
a type of ML model trained to provide CSI feedback;
a type of ML model trained to provide beam prediction in a time domain;
a type of ML model trained to provide beam prediction in a spatial domain; and
a type of ML model trained to provide positioning assistant information or UE position.

In an embodiment, the model type comprises one or more of:
a type of generalized ML model; and
a type of scenario-specific ML model.

In an embodiment, the model type comprises one or more of:
a one-side ML model, which means the ML model works either in a UE or a gNB; and
a two-side ML model, which means the ML model comprises two parts. One works a UE side, the other works at gNB side. The UE side model's output is the input of the gNB side model.

In an embodiment, the capability message comprises a maximum number of ML models supported by the wireless communication device. The maximum number of ML models supported by the wireless communication device is associated with the model type.

In an embodiment, the capability message comprises a set of capabilities of the wireless communication device for determining a complexity level of the wireless communication device.

In an embodiment, the capability message comprises the complexity level of the wireless communication device. The complexity level of the wireless communication device is associated with the model type. The set of capabilities of the wireless communication device comprises one or more of: a central processing unit (CPU), a memory size, a storage, floating-point operations per second (FLOPs), power, a buffer size, and a bus bandwidth of the wireless communication device.

The UE 10 activates one or more ML models according to UE capability in the capability message of the wireless communication device (S012).

With reference to FIG. 4, in an embodiment, the UE 10 transmits a capability message 200 of the wireless communication device to a source device (e.g., gNB 20) having a pool of machine learning (ML) models, wherein the capability message shows whether the wireless communication device is capable of executing multiple ML models (S010a). The source device (e.g., gNB 20) receives the capability message 200 (S012a) and determines a subset in the pool of ML models that matches the capability message of the wireless communication device (S013a).

The source device (e.g., gNB 20) transmits an indication 201 of the subset to the UE 10 (S014a). The subset comprises one or more ML models. The indication 201 may comprise a list of the one or more ML models in the subset.

The UE 10 downloads one or more ML models from the subset in the pool of ML models, wherein the subset in the pool of ML models match the capability message of the wireless communication device (S016a).

With reference to FIG. 5, in an embodiment, the UE 10 transmits a capability message 200 of the wireless communication device to a source device (e.g., gNB 20). The UE 10 has a pool of machine learning (ML) models. The capability message shows whether the wireless communication device is capable of executing multiple ML models (S010b). The source device (e.g., gNB 20) receives the capability message 200 (S012b) and determines a subset of ML models that matches the capability message of the wireless communication device (S013b).

The source device (e.g., gNB 20) transmits an indication 202 of the subset to the UE 10 (S014b). The subset comprises one or more ML models. The indication 202 may comprise a list of the one or more ML models in the subset.

The UE 10 activates one or more ML models deployed in the wireless communication device in response to the subset of ML models. (S016b).

As an alternative, the pool of ML models is in a third node. The third node can be a server, or a another gNB or a UE. The UE 10 reports its ability to support multiple ML models. The gNB 20 informs both the UE and the third node about:
i) the UE's ML model downloading; and
ii) the particular model name and complexity levels.

After the ML model downloading to the UE 10 is completed, the gNB activates the ML model.

### The UE Capability of Supporting Multiple AI/ML Models:

Whether UE 10 can support multiple AI/ML models is a type of UE capability of the UE 10. The UE capability can be signified by the UE 10 in a signal. For example, the content of the signal may comprise {Yes/No} or {0/1}, where “Yes” or “0” states that the UE 10 is capable of executing multiple AI/ML models, “No” or “1” states that the UE 10 is not capable of executing multiple AI/ML models.

In an embodiment, an AI/ML model name or an AI/ML model type is introduced and can be carried in a UE capability message. For simplicity, AI/ML model name and AI/ML model type are referred to as a type of model or a model type. For example, an AI/ML model name or an AI/ML model type may be shown as CSI_feeback_model, Beam_prediction_time, Beam_prediction_spatial, or positioning. CSI_feeback_model represents a type of a model trained to provide CSI feedback; Beam_prediction_time represents a type of a model trained to provide beam prediction in a time domain; Beam_prediction_spatial represents a type of a model trained to provide beam prediction in a spatial domain; and positioning represents a type of a model trained to provide positioning.
The supported number of AI/ML models may be sent with the model type of enhanced CSI feedback. An example of the message may be {CSI_feeback_model, n1}.
The supported number of AI/ML models may be sent with the model type of beam prediction in the time domain in a message. An example of the message may be {Beam_prediction_time, n2}.
The supported number of AI/ML models may be sent with the model type of beam prediction in the spatial domain in a message. An example of the message may be {Beam_prediction_spatial, n3}.
The supported number of AI/ML models may be sent with the model type of positioning in a message. An example of the message may be {positioning, n4}.

In the examples, each of {n1, n2, n3, n4} here is a non-negative integer indicating the supported number of a particular type of models. The message with a model type supported by the UE 10 can be categorized as one type of UE capability message.

In some examples, if at least one of {n1, n2, n3, n4} is left empty or is configured as “0” that means the corresponding type of ML model is not supported by a UE or a gNB.

Alternatively, a model type can be implicitly mentioned. For example, a model type can be implicitly indicated in a model deployment stage.

For example, the UE 10 may transmit a list of models supported by the UE 10 in a message to the gNB 20. For example, the message may comprise:

supportedMLModelList {
{supported_ML_model_nr , n}
...}.

The message with a list of models supported by the UE 10 can be categorized as one type of UE capability message.

In the example, supported_ML_model_nr represents the list of all the models supported by the UE 10, and n denotes the number of AI/ML models.

Alternatively, the UE 10 is operable to provide the aforementioned two kinds of UE capability message.

In an embodiment, multiple AI/ML models are supported by the gNB 20 and the UE 10.

The gNB 20 may indicate its supported AI/ML models in at least one of the following messages:
synchronization signal block (SSB);
master information block (MIB);
system information block zero (SIB0);
system information block one (SIB1);
radio resource control (RRC) signal; and
downlink control information (DCI).

The UE 10 may report its supported capability explicitly in a UE capability message.

The UE 10 may report its supported capability implicitly. For example, the UE 10 may report its supported capability implicitly using a dedicated frequency band number or a random access channel (RACH) sequence.

### 5.2 Support the Generalized AIML Model and Scenario-Specific AI/ML Model

In an embodiment, one generalized AI/ML model corresponds to several scenario-specific AI/ML models. To have a clear knowledge of the performance of a generalized AI/ML model, a UE 10 can simultaneously run at least two AI/ML models, including one generalized AI/ML model and one scenario-specific AI/ML model.

A generalized AI/ML model may be an AI/ML model that is trained with a data set A and tested with a data set B, where set A and set B does not include each other, or set A and set B are collected from different settings respectively.

A scenario-specific AI/ML model may be an AI/ML model which is not a generalized AI/ML model. The AI/ML model is trained with data set A and tested with data set C. The data of set A and the data set C are collected from the same settings.

Whether the performance of a generalized AI/ML model meets related requirements is critical to a telecommunication device at which the generalized AI/ML model is deployed. The performance of a generalized AI/ML model can be determined based on monitoring of the generalized AI/ML model. Thus, whether UE 10 can support a generalized AI/ML model is a type of UE capability in some examples.

Furthermore, in an embodiment of the disclosure, a telecommunication device performs AI/ML model management based on a relationship between the generalized AI/ML model and scenario-specific AI/ML model.

According to a mapping between a first generalized ML model and a first scenario-specific ML model, the first scenario-specific ML model serves as a backup ML model for the first generalized ML model, the first scenario-specific ML model is activated in response to deactivation of the first generalized ML model.

The mapping between the first generalized ML model and the first scenario-specific ML model may be determined based on an association between a model identifier of the first generalized ML model and a model identifier of the first scenario-specific ML model.

The mapping between the first generalized ML model and the first scenario-specific ML model may be determined based on an association between a parameter range of the first generalized ML model and a parameter range of the first scenario-specific ML model. For example, the first scenario-specific ML model works for a first parameter range, a second scenario-specific ML model works for a second parameter range, the first generalized ML model works for the first parameter range and the second parameter range, and the first scenario-specific ML model and the second scenario-specific ML model serve as backup ML models for the first generalized ML model.

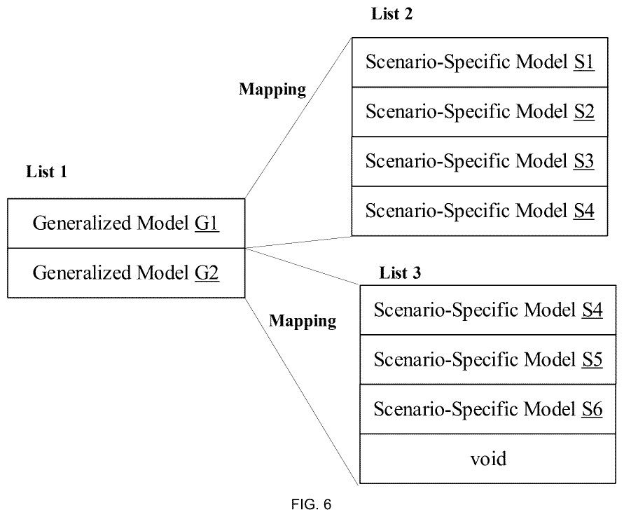

A mapping between a generalized AI/ML model G1 and scenario-specific AI/ML models S1, S2, S3, and S4 is shown in FIG. 6. The generalized AI/ML model G1 is associated with four scenario-specific models S1, S2, S3, and S4. The scenario-specific models S1, S2, S3, and S4 work for different parameter ranges, such as antenna angles, antenna geometry, antenna ports, beam width, SNR ranges, or channel RANKs, Doppler shift, time delay. The generalized AI/ML model G1 work for all of the parameter ranges. When the generalized AI/ML mode malfunctions in a parameter range, a model switching is triggered. In the model switching, the UE 10 deactivates the generalized AI/ML mode G1 malfunction that malfunctions in the parameter range and activates a scenario-specific AI/ML model work that works in the same parameter range. The scenario-specific AI/ML model work that works in the same parameter range is a backup model of the generalized AI/ML mode G1 in the parameter range.

A mapping between a generalized AI/ML model G2 and scenario-specific AI/ML models S4, S5, and S6 is shown in FIG. 6. The generalized AI/ML model G2 is associated with four scenario-specific models S4, S5, and S6. The scenario-specific models S4, S5, and S6 work for different parameter ranges, such as antenna angles, antenna geometry, antenna ports, beam width, SNR ranges, or channel RANKs, Doppler shift, time delay. The generalized AI/ML model G2 work for all of the parameter ranges. When the generalized AI/ML mode G2 malfunctions in a parameter range, a model switching is triggered. In the model switching, the UE 10 deactivates the generalized AI/ML mode malfunction that malfunctions in the parameter range and activates a scenario-specific AI/ML model work that works in the same parameter range. The scenario-specific AI/ML model work that works in the same parameter range is a backup model of the generalized AI/ML model G2 in the parameter range.

The missing model is indicated as void. If the generalized AI/ML mode malfunctions in a parameter range associated with the missing model indicated as void and has no backup model in a parameter range. In this case, if the generalized AI/ML has malfunctions, it has to fall back to non-AI method.

### Mapping Method:

The mapping between a generalized AI/ML model and a scenario-specific AI/ML model may be obtained by linking a model identifier (ID) of the generalized AI/ML model and a model ID of the scenario-specific AI/ML model.

Alternatively, the mapping is obtained based on a parameter range of training data and/or test data. For example, a mapping between a generalized AI/ML model and a scenario-specific AI/ML model may be obtained by associating a parameter range of the generalized AI/ML model and a parameter range of the scenario-specific AI/ML model. For example, the parameter range of the generalized AI/ML model is associated with the parameter range of the scenario-specific AI/ML model when the parameter range of the generalized AI/ML model contains the parameter range of the scenario-specific AI/ML model or when the parameter range of the scenario-specific AI/ML model contains the parameter range of the generalized AI/ML model. A mapping is obtained based on the association between the parameter range of the generalized AI/ML model and the parameter range of the scenario-specific AI/ML model. According to the mapping, the UE 10 uses the scenario-specific AI/ML model as a backup model of the generalized AI/ML model.

The differentiation of generalized AI/ML model and scenario-specific AI/ML models.

In a first scheme, the marking/indicating of a type of an AI/ML model in a UE capability message is represented by an explicit attribute in the AI/ML model. For example, a field {G/S} in the UE capability message of the UE 10 indicates whether the UE 10 can execute a type of a generalized AI/ML model and/or a type of a scenario-specific AI/ML model, where G denotes generalized AI/ML model, and S denotes scenario-specific AI/ML model. In some example, the {G/S} is explicitly bounded with model ID. For example G1000 indicates the ML model number “1000” is a generalized model, whereas “S2000”, indicates model “2000” is a non-generalized model (scenario-specific model).

In a second scheme, the marking/indicating of the type of an AI/ML model is represented by an implicit scheme. In an embodiment, a first range of ML model identifiers is allocated to the type of generalized ML model, and a second range of ML model identifiers is allocated to the type of scenario-specific ML model. For example, a first type of an AI/ML model (e.g., one of the type of a generalized AI/ML model or the type of a scenario-specific AI/ML model) is represented by a model ID range, and second type of an AI/ML model (e.g., the other one of the type of a generalized AI/ML model or the type of a scenario-specific AI/ML model) is represented by another model ID range. For example, model ID 00001 to model ID 10000 represents scenario-specific AI/ML model, while model ID greater than 10000 represents generalized AI/ML model.

In another embodiment, the UE 10 supports the two schemes.

### Complexity Level

UE capability of supporting ML models is indicated by a combination of one or more elements in a set Comp: {central processing unit (CPU), memory size, storage, floating-point operations per second (FLOPs), power, buffer size, bus bandwidth, and others}. CPU in the set may comprise a model name or a capability of a CPU of the UE 10.

In one example, the one or more elements in the set Comp are selected as UE capability and directly reported to gNB 20. The gNB 20 will decide the UE capability of the UE 10 regarding support of certain AI/ML models. For example, if the processing time of a certain amount FLOPs executed by the UE 10 is within a latency requirement of a model, the model can be deployed at UE 10.

In another example, one or more elements in set Comp are selected and converted to complexity levels.

For example, there can be 3 levels,
Level 1, low complexity;
Level 2, mid complexity; and
Level 3, high complexity.

Please note that the complexity levels are illustrated as examples and are not limited to three levels. Level 4, or 5, or even larger may be defined. The complexity level can begin from 0. In some examples, the complexity level is denoted as level a, level b, or level c, and more.

The complexity level of the UE 10 can be determined according to a formula or a rule for determining the complexity level. In an embodiment, the complexity level of the wireless communication device may be obtained from comparing a threshold with a weighted sum of elements in the set of capabilities of the wireless communication device.

In an embodiment, the complexity level of the wireless communication device may be obtained from comparing a threshold with most important element in the set of capabilities of the wireless communication device.

For example, the complexity level is determined by a weighted sum of elements in the set {FLOPs, number of parameters, model size, buffer size, power, bus bandwidth, and others}. A formula of the weighted sum is a rule for determining the complexity level.

For example, if a1·FLOPs+a2·number of parameters+a3·model size>threshold_1, the UE 10 has a complexity level 1 and is suitable to execute models for the level 1. In the example, a1, a2, and a3 are weight coefficients. The formula of the weighted sum is a rule for determining the complexity level of the UE 10.
if a1·FLOPs+a2·number of parameters+a3·model size>threshold_2, the UE 10 has a complexity level 2 and is suitable to execute models for the level 2. The formula of the weighted sum is a rule for determining the complexity level of the UE 10.

Alternatively, more factors or elements can be introduced into the threshold determination.

Alternatively, the most important element in {FLOPs, number of parameters, model size, buffer size, power, bus bandwidth, and others} is chosen and individually compared to a threshold to decide the complexity levels. For example, only the FLOPs is selected as the most important factor and is individually compared to a threshold to decide the complexity levels.

As an example, a formula or a rule for determining the complexity level is explicitly informed to the UE 10 from the gNB 20 and/or a third node. For example, a formula or a rule for determining the complexity level is carried in a downlink control information (DCI) signal, a radio resource control (RRC) signal, or a Medium Access Control (MAC) control element (CE).

In another example, a formula or a rule for determining the complexity level is implicitly informed to the UE 10 or the gNB 20. For example, a complexity level is given to the UE 10 at the manufacturing stage of the UE 10.

In some embodiments, the supporting of complexity level is a type of UE capability.

In some embodiments, the model type is introduced into a UE capability message.

In a UE capability message, the number of AI/ML models and a complexity level supported by the UE 10 are labeled with a model type. For example, the number of AI/ML models and a complexity level supported by the UE 10 are labeled with a model type CSI_feeback_model in a UE capability message {CSI_feeback_model, n, comp_level}. The “comp_level” indicates the complexity level, which can be low, mid, or high, or level 0, 1, 2, . . . , or level a, b, c, . . . . A model with the model type CSI_feeback_model comprises an autoencoder and an autodecoder for CSI feedback.

As an example, the comp_level indicated a complexity level associated with an autoencoder of the CSI_feeback_model.

In another example, the comp_level indicated a complexity level associated with an autodecoder of the CSI_feeback_model.

In another example, the comp_level indicated both the autoencoder and the autodecoder of the CSI_feeback_model.

For example, the number of AI/ML models and a complexity level supported by the UE 10 are labeled with a model type Beam_prediction_time in a UE capability message {Beam_prediction_time, n, comp_level}.

For example, the number of AI/ML models and a complexity level supported by the UE 10 are labeled with a model type Beam_prediction_spatial in a UE capability message {Beam_prediction_spatial, n, comp_level}

For example, the number of AI/ML models and a complexity level supported by the UE 10 are labeled with a model type positioning in a UE capability message {positioning, n, comp_level}

In the example, n denotes the number of AI/ML models.

For example, the UE 10 may transmit a list of models supported by the UE 10 in a message to the gNB 20. For example, the message may comprise:

supportedMLModelList {
{supported_ML_model_no , comp_level}
...}.

The complexity level is included in the message.

The model type can be implicitly indicated, e.g., in the model deployment stage. Alternatively, the UE 10 is operable to provide the aforementioned two kinds of UE capability message.

In some embodiments, the complexity level is an attribute of each AI/ML model. The attribute accompanies with the AI/ML model in a model image or a packet of the AI/ML model.

As an example, the complexity level relates to one or more elements in set Comp. In another example, the complexity level relates to the computing capability in model inference 107 and may comprises one or more elements in a set {FLOPs, number of parameters, model size, and others}.

In an embodiment, the UE 10 reports successful deployment of a first download ML model in the downloaded one or more ML models when a complexity level of the first download ML model matches the complexity level of the wireless communication device.

The UE 10 reports unsuccessful deployment of the first download ML model in the downloaded one or more ML models when the complexity level of the first download ML model matches the complexity level of the wireless communication device.

During model deployment, the UE 10 determines whether the complexity level of a model is the same as a complexity level of the UE 10 in a configuration of the UE 10. If the complexity level of the model is the same as the complexity level of the UE 10 in the configuration of the UE 10, the UE 10 will report that the deployment is successful. Otherwise, the UE 10 will report that the deployment is unsuccessful due to an unsupported model complexity level. Or, as one configuration, the alignment of a model complexity level of the monitoring model and a model complexity level of the monitored model is one factor for determining whether the deployment is successful.

In the example of FIG. 5, the UE 10 reports successful deployment of a first activated ML model in the activated one or more ML models when a complexity level of the first activated ML model matches the complexity level of the wireless communication device.

Additionally, the UE 10 reports unsuccessful deployment of the first activated ML model in the activated one or more ML models when the complexity level of the first activated ML model matches the complexity level of the wireless communication device.

In some embodiments, if no configuration for complexity level is available to the UE 10, the UE 10 may determine whether the UE 10 can support a complexity level of a deployed AI/ML model. When the UE 10 can support the complexity level of the deployed AI/ML model, the UE 10 reports successful deployment (i.e., the deployment is successful). Otherwise, UE 10 reports unsuccessful deployment (i.e., the deployment is unsuccessful) due to unsupported complexity.

### The Correlation of UE Capability.

A set of UE capabilities may be correlated to another set of UE capabilities. In an embodiment, two sets of UE capabilities are given as an example and detailed in the following. One of the two sets is referred to as a first set of UE capabilities, the other is referred to as a second set of UE capabilities. In an embodiment, a first set of UE capabilities of the wireless communication device is disabled in response to enabling of a second set of UE capabilities of the wireless communication device. In another embodiment, the first set of UE capabilities of the wireless communication device is enabled in response to enabling of the second set of UE capabilities of the wireless communication device. Each of the first set of UE capabilities and the second set of UE capabilities of the wireless communication device comprises one or more of the following associated with one of the downloaded one or more ML models:
training, inference, monitoring, on-line training, data collection, post-processing, fine-tuning, and pre-processing,

### The First Set of UE Capabilities are Disabled in Response to Enabling of the Second Set of UE Capabilities.

For example, as being restricted by limited resources on UE 10, if the resources on UE 10 have been configured for training for a model A, the UE 10 has no sufficient resources for post-processing a model B.

For example, if a model executed by UE 10 is in an inferencing mode, the model cannot be configured as online training on UE 10.

As an example, the deployment or activation of a first model may occupy a certain amount of resources, which may prevent a second model from post-processing (fine-tuning) and/or online-training.

In another example, although the UE 10 has UE capability to support two AI/ML models, the deployment of a model of high level complexity can prevent the deployment of another model of low level complexity.

As an example, the first set of UE capabilities may comprise at least one of {training, inference, monitoring, on-line training, data collection, post-processing, fine-tuning, pre-processing}, As an example, the second set of UE capabilities may comprise at least one of {training, inference, monitoring, on-line training, data collection, post-processing, fine tuning, pre-processing}

Alternatively, the first set of UE capabilities for model A are disabled in response to the configurations related to/enabling of the second set of UE capabilities for model B.

In an embodiment, the UE 10 has two sets of UE capabilities, including a second set of UE capabilities and a third set of UE capabilities.

### A Third Set of UE Capabilities are Enabled in Response to the Enabling of the Second Set of UE Capabilities.

In some embodiments, the fine-tuning for a model in the UE 10 is enabled together with model training. If on-device training is enabled for a model, the fine-tuning is a lightweight operation compared with training and can be enabled jointly with training.

As an example, the first set of UE capabilities may comprise at least one of {training, inference, monitoring, on-line training, data collection, post-processing, fine-tuning, pre-processing}. As an example, the third set of UE capabilities may comprise at least one of {training, inference, monitoring, on-line training, data collection, post-processing, fine-tuning, pre-processing}.

In an alternative, the first set of UE capabilities for model A are enabled in response to enabling of the third set of UE capabilities for model B.

Alternatively, the UE 10 has three set of UE capabilities, including a first set of UE capabilities, a second set of UE capabilities, and a third set of UE capabilities.

The first set of UE capabilities are disabled in response to enabling of the second set of UE capabilities.

A third set of UE capabilities are enabled in response to enabling of the second set of UE capabilities.

As an example, the first set of UE capabilities may comprise at least one of {training, inference, monitoring, on-line training, data collection, post-processing, fine-tuning, pre-processing}. The second set of UE capabilities may comprise at least one of {training, inference, monitoring, on-line training, data collection, post-processing, fine-tuning, pre-processing}. The third set of UE capabilities may comprise at least one of {training, inference, monitoring, on-line training, data collection, post-processing, fine-tuning, pre-processing}.

Alternatively, the first set of UE capabilities for model A are disabled in response to enabling of the second set of UE capabilities for model B. The third set of UE capabilities for model A are enabled in response to enabling of the second set of UE capabilities for model B.

### UE Status Reporting:

As UE 10 moves from an original cell served by an original gNB (e.g., one of the base station 20a or 20b) into a new cell served by a new gNB (e.g., the other one of the base station 20a or 20b). The new gNB needs to know the UE 10 status. The wireless communication device comprises a user equipment (UE). The source device comprises a base station. The UE 10 performs a handover operation from an original base station to a new base station, the UE reports the capability message to the new base station.

The capability message comprises a status of the UE. The status of the UE shows which ML model has been deployed or activated by the UE and how many ML models of a specific complexity level are deployable to the UE. The capability message may be transmitted in a physical uplink control channel (PUCCH) and/or a physical uplink shared channel (PUSCH) to the new base station. For example, If the UE 10 supports deploying two AI/ML models, while current one model is running/activated. The UE 10 has only limited resources for another AI/ML model.

The UE 10 should report these conditions to the new gNB 20, and the new gNB can accordingly deploy and activate a proper AI/ML model. For example, the new gNB or deactivate the current deployed AI/ML model and deploy a new model with high complexity. Please note the “low” and “high” here corresponds to different complexity (or complexity levels), respectively.

Thus UE 10 report its status in UE capability

For example, UE capability can comprise:

| | |
|---|---|
| {supportMLmodels, | {{2, low} , |
| | {1, high}} } |

Where 2 and 1 are the number of models supported by the UE 10. In the example, 2 denotes two low complexity models, or 1 denotes one high complexity model.

UE 10 should report this condition to the new gNB 20 in a UE capability message. The capability message, for example, may be in the format:
{CurrentDeployedModel/CurrentActivatedModel {1, low}.

In the example, {1, low} states that the UE 10 has one currently deployed model of a low complexity level.

Alternatively, the original gNB transmits this condition in a UE capability message to the new gNB via X2/Xn interface. The UE capability message, for example, may be in the format:

| | |
|---|---|
| {supportMLmodels, | {{2, low} , |
| | {1, high}}}. |

The UE capability message, for example, may be in the format:
{CurrentDeployedModel/CurrentActivatedModel {1, low}.

Note that in the embodiment, the status of the UE 10 is reported in a UE capability message to the new gNB.

Alternatively, UE 10 reports its status in a UE capability message and transmits the UE capability message in a physical uplink control channel (PUCCH) and/or a physical uplink shared channel (PUSCH) to the new gNB.

Alternatively, UE 10 replies its status in response to a request from the new gNB and/or the original gNB.

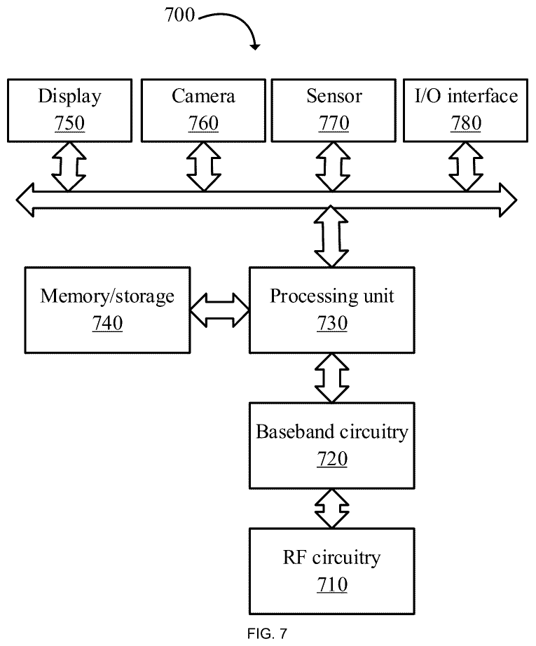

FIG. 7 is a block diagram of an example system 700 for wireless communication according to an embodiment of the present disclosure. Embodiments described herein may be implemented into the system using any suitably configured hardware and/or software. FIG. 7 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

In various embodiments, the system 700 may be a mobile computing device such as, but not limited to, a laptop computing device, a tablet computing device, a netbook, an ultrabook, a smartphone, etc. In various embodiments, the system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that can be adopted in 3GPP specification to create an end product.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random-access memory (RAM), a floppy disk, or other kinds of media capable of storing program codes.

The disclosure provides a device capability discovery method based on machine learning. The invention provides embodiments to address problems in ML model deployment.

Multiple AI/ML models can run in a set of telecommunication devices, such as a UE and/or a gNB. Some embodiments of the disclosure provide a mechanism that enables a UE to support multiple AI/ML models. It is more general and reasonable for a UE to run multiple ML models.

Some embodiments of the disclosure provide relationships between model complexity and UE capability. With the relationships between model complexity and UE capability, the UE and gNB can support diverse AI/ML models easily with various complexity levels. Rather than handling the hardware details of a UE or individual model details of parameter number, model size and etc., a simplified rule or protocol is provided to associate model complexity and UE capability.

The UE capability becomes configurable for the deployment of at least one AI/ML model. The relation/correlation between detailed UE capabilities is investigated.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A device capability discovery method for machine learning (ML), executable in a wireless communication device, comprising:
transmitting a capability message of the wireless communication device to a source device having machine learning (ML) models, wherein the capability message shows whether the wireless communication device is capable of executing multiple ML models; and
downloading and activating one or more ML models from a subset of ML models, wherein the subset of ML models matches the capability message of the wireless communication device.

2. The method of claim 1, wherein the capability message comprises a model type.

3. The method of claim 2, wherein the model type comprises one or more of:
a type of ML model trained to provide CSI feedback;
a type of ML model trained to provide beam prediction in a time domain;
a type of ML model trained to provide beam prediction in a spatial domain; and
a type of ML model trained to provide positioning.

4. The method of claim 2, wherein the model type comprises one or more of:
a type of generalized ML model; and
a type of scenario-specific ML model.

5. The method of claim 4, wherein a first range of ML model identifiers is allocated to the type of generalized ML model, and a second range of ML model identifiers is allocated to the type of scenario-specific ML model.

6. The method of claim 4, wherein according to a mapping between a first generalized ML model and a first scenario-specific ML model, the first scenario-specific ML model serves as a backup ML model for the first generalized ML model, the first scenario-specific ML model is activated in response to deactivation of the first generalized ML model.

7. The method of claim 6, wherein the mapping between the first generalized ML model and the first scenario-specific ML model is determined based on association between a model identifier of the first generalized ML model and a model identifier of the first scenario-specific ML model.

8. The method of claim 6, wherein the mapping between the first generalized ML model and the first scenario-specific ML model is determined based on association between a parameter range of the first generalized ML model and a parameter range of the first scenario-specific ML model.

9. The method of claim 8, wherein the first scenario-specific ML model works for a first parameter range, a second scenario-specific ML model works for a second parameter range, the first generalized ML model works for the first parameter range and the second parameter range, and the first scenario-specific ML model and the second scenario-specific ML model serve as backup ML models for the first generalized ML model.

10. The method of claim 2, wherein the capability message comprises a maximum number of ML models supported by the wireless communication device.

11. The method of claim 10, wherein the maximum number of ML models supported by the wireless communication device is associated with the model type.

12. The method of claim 1, wherein the capability message comprises a set of capabilities of the wireless communication device for determining a complexity level of the wireless communication device; or
the capability message comprises the complexity level of the wireless communication device.

13. The method of claim 12, wherein the complexity level of the wireless communication device is associated with the model type.

14. The method of claim 12, further comprising:
reporting successful deployment of a first download ML model in the downloaded one or more ML models when a complexity level of the first download ML model matches the complexity level of the wireless communication device; and
reporting unsuccessful deployment of the first download ML model in the downloaded one or more ML models when the complexity level of the first download ML model does not match matches the complexity level of the wireless communication device.

15. The method of claim 12, wherein the set of capabilities of the wireless communication device comprises one or more of:
a central processing unit (CPU), a memory size, a storage, floating-point operations per second (FLOPs), power, a buffer size, and a bus bandwidth of the wireless communication device.

16. (canceled)

17. (canceled)

18. The method of claim 1, wherein a first set of UE capabilities of the wireless communication device is disabled in response to enabling of a second set of UE capabilities of the wireless communication device; or
the first set of UE capabilities of the wireless communication device is enabled in response to enabling of the second set of UE capabilities of the wireless communication device.

19-29. (canceled)

30. A device capability discovery method for machine learning (ML),
executable in a wireless communication device, comprising:
transmitting a capability message of the wireless communication device to a source device, the wireless communication device has machine learning (ML) models, wherein the capability message shows whether the wireless communication device is capable of executing multiple ML models;
receiving an indication showing a subset of ML models, wherein the subset of ML models matches the capability message of the wireless communication device; and
activating one or more ML models deployed in the wireless communication device in response to the subset of ML models.

31-53. (canceled)

54. A wireless communication device comprising:
a processor, configured to call and run a computer program stored in a memory, to cause a device in which the processor is installed to execute the method of claim 1.

55. A chip, comprising:
a processor, configured to call and run a computer program stored in a memory, to cause a device in which the chip is installed to execute the method of claim 1.

56. A computer-readable storage medium, in which a computer program is stored, wherein the computer program causes a computer to execute the method of claim 1.

57-58. (canceled)
